(19) United States
(12) Patent Application Publication
(10) Pub. No.: US 2025/0390550 A1
(43) Pub. Date: Dec. 25, 2025

(54) Method for accelerated solving of large sparse matrix, system and storage medium thereof

(71) Applicant: XPEEDIC CO., LTD., SHANGHAI (CN)

(72) Inventors: Wenliang DAI, SHANGHAI (CN); Liguo JIANG, SHANGHAI (CN); Feng LING, SHANGHAI (CN); Jian ZHANG, SHANGHAI (CN); Ping LIU, SHANGHAI (CN); Feng MIAO, SHANGHAI (CN)

(73) Assignee: XPEEDIC CO., LTD., SHANGHAI (CN)

(21) Appl. No.: 18/879,773

(22) PCT Filed: Apr. 11, 2023
(86) PCT No.: PCT/CN2023/087434

§ 371 Date: Dec. 29, 2024

(30) Foreign Application Priority Data
Jul. 6, 2022 (CN) 202210796031.7

(51) Int. Cl. G06F 17/16

(52) U.S. Cl. CPC G06F 17/16

(57) ABSTRACT

The present invention discloses a method for accelerated solving of large sparse matrix, system and storage medium thereof, which falls into the technical field of electromagnetic field computation. In view of the problem that solving of the current large sparse matrix is slow and not accurate enough, the present invention provides a method for accelerated solving of large sparse matrix, comprising: restoring connection relationships between port nodes of an initial finite element matrix, and obtaining restored second-order finite element matrix; converting the second-order finite element matrix to an undirected graph; decomposing the undirected graph, and selecting optimal decomposition via an evaluation function; renumbering nodes of the second-order finite element matrix according to the renumbered nodes and generating a new final finite element matrix; and solving the final finite element matrix. In the present invention, by restoring the connection relationships of port nodes the subsequent solving accuracy is promised, by converting the matrix to the undirected graph and decomposing, the optimal decomposition is obtained and by going on with the subsequent operations as per the optimal decomposition, the solving of the matrix is accelerated.

### TECHNICAL FIELD

The present invention relates to the technical field of computational electromagnetics, specifically, relates to a method for accelerated solving of large sparse matrix, system and storage medium thereof.

### BACKGROUND TECHNOLOGY

Modern EDA simulation tools for circuit analysis and 3D electromagnetic field analysis, faces a problem that with the increasing simulation magnitude, computation is slower and slower. For circuit problems, the slowing down of computation is resulted from the huge amount of voltage nodes and branch current nodes in the complex circuits; and for 3D electromagnetic field problems, in case of employing finite element analysis, reduction of computation speed can be attributed to the number of dense grids. Mathematically, the huge amount of voltage nodes and current nodes or dense grids corresponds to a sparse matrix of a very high dimension. How to solve a large sparse matrix while promising computation accuracy is a common problem existing in the modern EDA industry. In view of this problem, traditional solution is to solve by writing a sparse matrix solver which is more efficient, for example, some well-known matrix solving software Umfpack, Pardiso, KLU etc. By solving large-scale matrices with the matrix solving programs, the computation efficiency is far higher than that achieved by writing matrix solving programs. However, the common matrix solving software is not good at dealing with the specific issues faced in the EDA industry, such as to analyze non-linear circuits with ibis models, or to analyze the DC voltage of a circuit board etc. In the former case, due to the influence of being non-linear, every time step during computation faces the large matrix inversion problem, while in the latter case, by considering separately the power plane and the ground plane, the large matrix can be decoupled strictly. It is difficult to solve the foregoing problems by the conventional matrix solvers, and new thoughts and methods are demanded.

The computation method commonly used in the EDA industry takes use of 3D electromagnetic field theories and finite element algorithms in order to analyze the signal/power integrity of chip/package/board and electromagnetic compatibility, which is efficient and mature, such as HFSS by Ansys, Clerity3D by Cadance, which use finite elements to compute and analyze the 3D electromagnetic fields. However, the signal working frequency is higher and higher, the size of the chips is smaller and smaller, and internal structures of chips become more and more complicated. When dealing with such problems, commercial EDA simulation tools increase the computation complexity due to requirements of 3D modeling on fine grids, the amount of the unknown quantity rises from tens of thousands, hundreds of thousands to millions, in such case, solving of the matrix is slower. In a design, an engineer may usually need to wait for days or weeks for a computation result, which consumes a lot of time, and is a serious problem for all of the EDA designers, chip designers and manufacturers.

Several improvements were made in view of the foregoing problems, for example, the China patent application number CN202110024925.X, disclosed on Apr. 30 2021, taught a sparse matrix accelerated solving method, comprising, reading a first sparse matrix to be multiplied, conducting non-zero detection for the first sparse matrix, generating first status information of data in each line of the first sparse matrix according to the detection result, and storing the same in a memory; storing the non-zero data in the first sparse matrix detected in an RAM; reading a second sparse matrix to be multiplied, conducting non-zero detection for the second sparse matrix, generating second status information of data in each line of the second sparse matrix according to the detection results and storing the same in the memory; finally conducting logic operations for the first status information and the second status information, reading the data in the RAM according to the logic operation results and multiplying with the data in the second sparse matrix to obtain data of product matrixes. The deficiency with the said patent application lies in that, although the reading amount during computation is reduced to accelerate the speed, the treatment precision cannot be promised.

### SUMMARY OF THE INVENTION

### 1. The Problem to be Solved

In view of the problem that the solving efficiency of the current large sparse matrix is low and has poor precision, the present invention provides a method for accelerated solving of large sparse matrix, system and storage medium thereof. In the present invention, by restoring connection relationships of ports and nodes subsequent solving accuracy can be promised, by converting the matrix to be undirected graphs and decomposing for optimal decomposition, by conducting subsequent decomposition based on optimal decomposition the matrix solving speed is greatly improved. The system provided in the present invention is simple, while accuracy is promised, the treatment efficiency is guaranteed, good balance is reached in between accuracy and efficiency.

### 2. Technical Solution

To address the foregoing problems, the present invention uses the following technical solution: A method for accelerated solving of large sparse matrix, comprising:
S1: restoring connection relationships in between port nodes for an initial finite element matrix and obtaining restored second-order finite element matrix;
S2: converting the second-order finite element matrix to be an undirected graph;
S3: decomposing the undirected graph, and selecting optimal decomposition via an evaluation function;
S4: renumbering nodes of the second-order finite element matrix according to the optimal decomposition;
S5: re-sequencing the second-order finite element matrix according the renumbered nodes and generating a new final finite element matrix; and
S6: solving the final finite element matrix.

Further, the step S2 comprises:
S21: defining two new data structures: dots and edges, dots: a column where a non-zero element is located comprises a node corresponding to a line, and the line is the line where the non-zero element is located; edges: an edge formed by a node corresponding to the column where the non-zero element is located;
S22: mapping every non-zero element in each line of the second-order finite element matrix to be dot-dot connection relationships;
S23: every two dots correspond to an undirected edge; and
S24: repeating the steps S22 to S23 in sequence, until the connection relationships are formed in between the non-zero elements in each line of the second-order finite element matrix and generating finally the undirected graph.

Further, in the step S3, a definition of the evaluation function is: decomposing a matrix to be N sub-matrices, N is a multiple of 2, a coupling coefficient of the sub-matrices S is obtainable by dividing a dimension of a coupling matrix with an average dimension of the sub-matrices, and the optimal decomposition comprises a number of sub-matrices where the coupling coefficient is minimum.

Further still, in the step S3 Metis program is used for decomposition of the undirected graph.

Still further, in the step S1, the initial finite element matrix comes from: reading grid files, modeling finite element values via grids and creating the matrix.

Still further, in the step S1, while generating the initial finite element matrix, copying the connection relationships of the port nodes and other grid nodes for back-up.

A system employing the method for accelerated solving of large sparse matrix as recited, comprising:
A restoration module: configured to restore the connection relationships of the ports and nodes for the initial finite element matrix and obtaining the second-order finite element matrix;
A conversion module: configured to convert the second-order finite element matrix to be un-directed graphs;
A decomposition module: configured to decompose the un-directed graphs and achieving optimal decomposition;
A renumbering module: configured to renumber the nodes in the second-order finite element matrix according to the optimal decomposition of the decomposition module;
A re-sequencing module: configured to re-sequence the second-order finite element matrix according to the renumbered nodes in the renumbering module and generate the final finite element matrix;
A solving module: configured to solve the final finite element matrix in the re-sequence module; and
A control module: configured to control work of the other modules.

A computer readable storage medium, wherein a computer program is stored in the computer readable storage medium, wherein the computer program will execute the method as recited above when being executed by a processor.

### 3. Beneficial Effect

Compared with the prior art, the beneficial effects of the present invention are as follow:
(1) In the present invention, where to solve a large sparse matrix, first of all, by restoring the connection relationships in between the port nodes for the initial finite element matrix, topological integrity of the matrix is promised, supports of high accuracy and completeness are provided for subsequent steps, and the accuracy of the entire process is promised; secondly, by converting the second-order finite element matrix to the un-directed graph and decomposing, the expenses and efficiency problem due to decomposing of the grid files in the past can be changed; furthermore, by renumbering the nodes of the second-order finite element matrix according to the optimal decomposition and generating the new final finite element matrix, very large coupling matrices in the final finite element matrix can be avoided, the matrix solving speed can be accelerated; finally, by using and solving the final finite element matrix, the solving speed is further improved; with the present method, while the solving precision is promised, the solving efficiency is greatly improved, the operation is simple and easy to implement, and can be widely used in the EDA industry;
(2) In the present invention, by defining the two new data structures, dots and edges, scanning the lines in the second-order finite element matrix, obtaining relationships between all the dots and edges, a un-directed graph is generated, subsequently, by decomposing the un-directed graph and obtaining optimal decomposition, the efficiency is improved, IO communication between the program and the disk due to direct decomposition of the finite element grid files in the past and additional expenses generated other than reading the finite element grid files are avoided; further still, with the evaluation function, the number of sub-matrices corresponding to the smallest coupling coefficient is selected as the optimal decomposition, which is more accommodated to non-linear matrices and can help a lot in improving the subsequent computation efficiency;
(3) With the system provided in the present invention, by restoring the connection relationships in between the port nodes of the initial finite element matrix, converting the initial finite element matrix to be a un-directed graph, decomposing the un-directed graph, obtaining the optimal decomposition, renumbering the nodes in the second-order finite element matrix according to the optimal decomposition and re-sequencing the matrix according to the renumbering results, the matrix is solved; while promising the precision, the efficiency is improved, the modules are working individually and synergically, the structure is simple and the control is easy.

### BRIEF DESCRIPTION OF DRAWINGS

FIG. 1 is a flow chart diagram showing the present invention;

FIG. 2 is a topological relation graph showing an original matrix;

FIG. 3 is a topological relation graph showing a decomposed matrix;

FIG. 4 shows solving of a large system matrix;

FIG. 5 is a schematic diagram showing solving of the decomposed matrix;

FIG. 6 is a schematic diagram showing restoring connection relationships in between nodes and ports;

FIG. 7 is a schematic diagram showing converting to a un-directed graph; and

FIG. 8 is a diagram showing conversion of the final finite element matrix.

### EMBODIMENTS

Hereinafter a further description will be given to the present invention in conjunction with the embodiments and the drawings.

In the EDA industry, with the increasing signal working frequency, the reducing size of chips, the internal structures of chips are more and more complex, the number of unknown quantity in the grids rises from tens of thousands, hundreds of thousands to millions, in such case, solving of the matrices becomes slower. In the present invention, the situation is considered along with the features of the EDA circuits/electromagnetic fields, by taking use of the information in the sparse matrix, restoring the topological and connection relationships between the circuits and grids, decomposing the topology corresponding to the matrix using the graph decomposition techniques, rearranging the decomposed graphs in the matrix, generating a matrix with a special mode, which is usually called a strip-line bordered sparse matrix, thereafter, solving the coefficient matrix using mathematic knowledge, the problem that the solving of the large sparse matrices is slow in the industry can be solved. For a matrix with a dimension of n (n is usually hundreds of thousands or millions), by dividing the matrix to k sub-matrices with a dimension of p, the k sub-matrices can be coupled by a matrix with a dimension of m. For the k sub-matrices, the computation for matrix inversion operation is k*p\hat{ }3; for the coupling matrix, the computation required for matrix inversion is m\hat{ }3. For the decomposed matrix, the total computation amount is k*p\hat{ }3+m\hat{ }3, wherein k*p+m=n. Where the matrix dimension n is very big, so as to have the decomposed matrices to satisfy p>>m, the computation after decomposition k*p\hat{ }3+m\hat{ }3 is approximately k*p\hat{ }3, the computation for the matrix that has not been decomposed (k*p+m)\hat{ }3 is approximate to (k*p)\hat{ }3. It can be seen that, (k*p)\hat{ }3 is far bigger than k*p\hat{ }3! Further given that computation of the sub-matrices can be parallel to complete inversion operation, no matter the computation amount or the computation time, the decomposed matrix has a higher solving efficiency than the matrix that is not decomposed. Please find the following paragraphs for the specific technical solutions.

### Embodiment 1

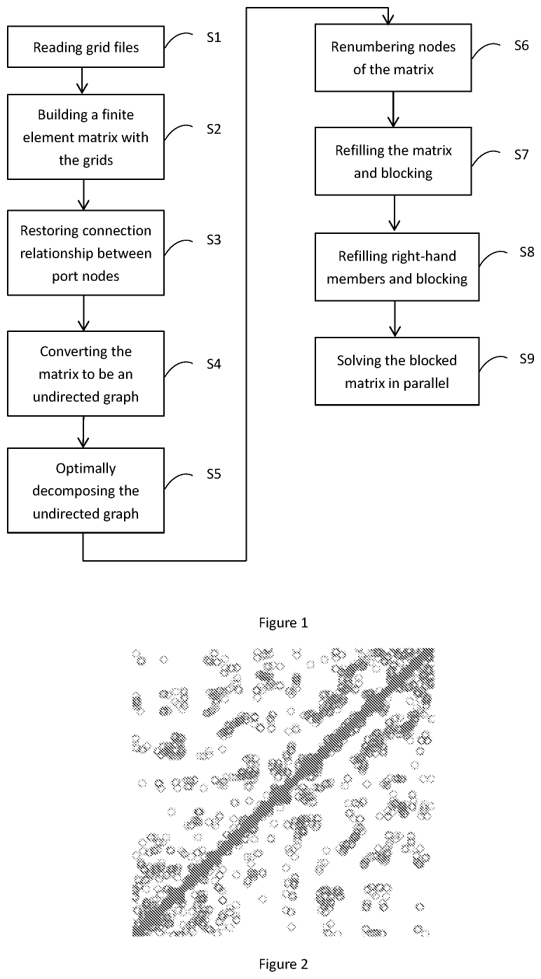

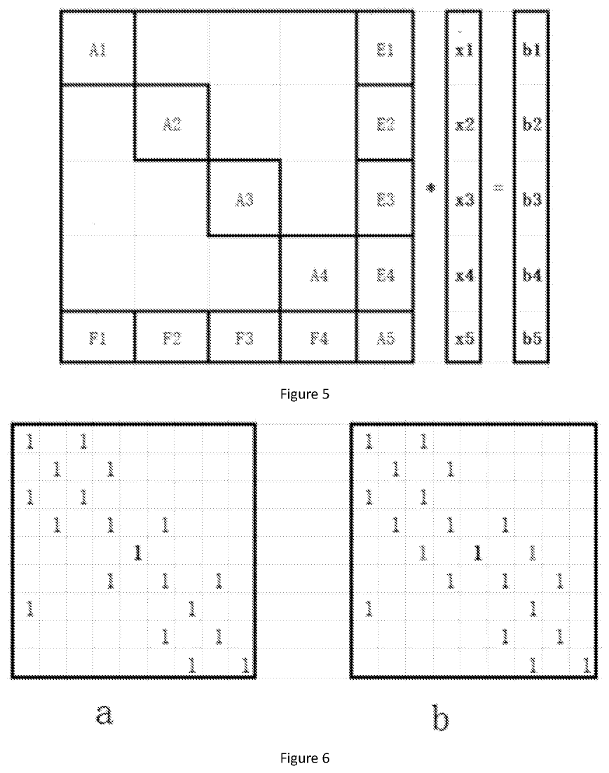

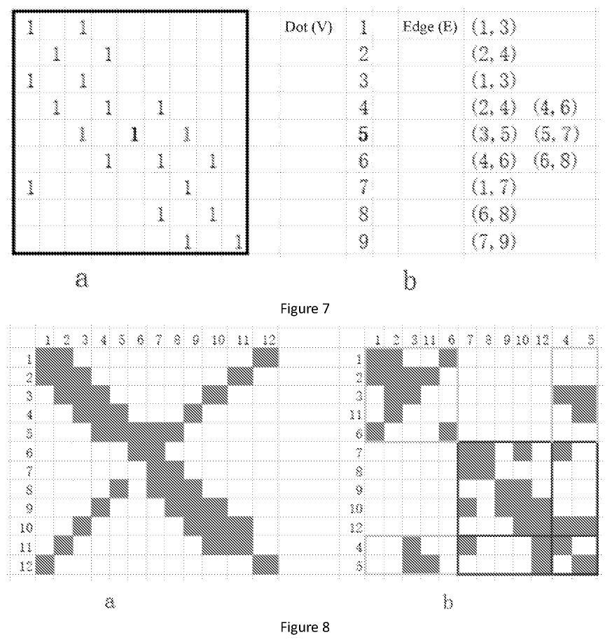

As shown in FIG. 1, a method for accelerated solving of large sparse matrix, comprises the following steps:
S1: restoring connection relationships in between port nodes in the original finite element matrix, obtaining restored second-order finite element matrix; specifically, as shown in FIG. 6, the a in the left portion of FIG. 6 represents the initial finite element matrix, only one non-zero element 1 (the fifth line in a corresponds to the line where the ports and nodes are located) is on the line where the port and node of the initial finite element matrix is located, the connection relationships between the ports and nodes and the other nodes are hidden, so that the connection relationships between the port nodes and other nodes cannot be obtained by the non-zero elements on the line where the port nodes are located. As there are decomposition and de-blocking steps subsequently in the present invention, if the connection relationships between the port nodes and the other nodes in the matrix are not restored, the connection relationships are not complete, virtual decomposition or decomposition errors may occur in the subsequent decomposition steps, virtual decomposition may result in differences of condition numbers of the sub-matrices after de-blocking, and affect the precision of the computation results. Therefore, in the present step, the connection relationships between the port nodes and the other nodes in the initial finite element matrix are restored, a graph b in the right portion of FIG. 6 is obtained, b represents the restored second-order finite element matrix, from the graph b, it can be known that a non-zero element 1 is present at both sides of the port node in the line 5, that is, there is a connection relationship in between the port node 5, the grid node 3 and the grid node 7; furthermore, restoring in the present step is done accompanying generating the initial finite element matrix, the connection relationship between the port node and the other grid nodes is copied for back-up without altering the initial finite element matrix, the operation is convenient; and by reading and analyzing the grid files in the chip structure, modeling the finite element values via the grids and creating the matrix, the initial finite element matrix is obtained, the topological relationship of the initial finite element matrix is as shown in FIG. 2, it is commonly seen to model the finite element values and create the matrix via the grids, which can be found in “electromagnetic field finite element method”, does not fall into the core improvements made in the present invention, and will not be repeated here;
S2: converting the second-order finite element matrix to be an un-directed graph as shown in FIG. 7; specifically, the step S2 comprises:
S21: defining two new data structures: dots and edges, dots: a column where a non-zero element is a node corresponding to the line, the line is defined as the edge where the non-zero element is; edges, edges formed by nodes corresponding to the column where the non-zero element is;
S22: mapping the non-zero element in each line of the second-order finite element matrix (a in the left portion of FIG. 7) to be dot-dot connection relationships;
S23: every two dots define an un-directed edge;
S24: repeating the steps S22-S23, until the connection relationships exist in between the non-zero element in each line of the second-order finite element matrix, generating the dot and edge relationships to be a un-directed graph (as shown in b in the right portion of FIG. 7, wherein b in the right portion represents data structures of the un-directed graph, the red numbers represent nodes having connection relationships with the port nodes being restored); specifically, as shown in FIG. 7, each line corresponds to a dot I, a position where the non-zero element (suppose 1 herein) corresponds to a dot J having a connection relationship with the point I, by combination of two vector types, V and E can show completely how many dots there are in the matrix or the graph, dot-dot connection is done in this way, as connection between I and J and connection between J and I is recorded twice, the graph is un-directed, and a set formed by V and E comprises the un-directed graph;
S3: decomposing the un-directed graph, and selecting optimal decomposition by employing an evaluation function; it shall be noted that, with conventional methods, the grid files are directly decomposed, usually the grid files are stored in a hard disk, and can be treated only by reading the memory with a graph decomposition program, and storing the decomposed outcomes to be new files, which requires establishing IO communication in between the graph decomposition program and the magnetic disk, additional expenses are generated besides reading the grid files; however, in the present invention, in contrary to conventional methods, in the present step, by starting from the matrix where the grid files are set and restoring the connection relationships between port nodes for the initial finite element matrix, a second-order finite element matrix is obtained, topological integrity of the second-order finite element matrix is promised; in the present invention, the grid files are not directly decomposed, the second-order finite element matrix is firstly converted to be an un-directed graph and then decomposed, additional expenses due to reading the grid files in the hard disk is avoided; and in the present step, decomposition of the un-directed graph is done with the Metis program, the decomposition accuracy is high and the technology is mature;
In the present step, the evaluation function is used for optimal decomposition, setting of the evaluation function is to have the decomposition program to judge automatically the optimal decomposition results, decompose the un-directed graph into an appropriate number to avoid the problem that the coupling matrices in the new matrices may be too large and accelerate parallel computation efficiency. Specifically, the evaluation function is defined as: for a matrix (in the present example a second-order finite element matrix), the matrix is to be decomposed into N sub-matrices, N is a multiple of 2, a coupling coefficient S of the sub-matrices is defined by dividing the dimension of the coupling matrix with the average dimension of the sub-matrices, the optimal decomposition corresponds to a number of blocks corresponding to the minimum value of the coupling coefficient. This solution has a better applicability for non-linear matrices, and can help a lot in improvement of subsequent computation efficiency.
S4: renumbering the nodes of the second-order finite element matrix according to the optimal decomposition; specifically, renumbering the nodes of the second-order finite element matrix taking use of the optimal decomposition solution according to different partitions, that is, to correspond coordinates (I, J) of the new matrices finally generated to correspond to the coordinates of the nodes in the original matrix (i, j), set up a set of node mapping, for example, the original numbers of the second-order finite element matrix are 1, 2, 3, 4, 5, 6, 7, 8, 9, 10, 11, 12; the numbers of the new matrices after optimal decomposition are 1, 2, 3, 11, 6, 7, 8, 9, 10, 12, 4, 5, and with the new numbers blocked matrices can be re-generated quickly;
Specifically, to illustrate the step S4 with an example, for example, a dimension of the second-order finite element matrix is 12, as shown in FIG. 8, there are 12 nodes, suppose the initial numbers are serial {1, 2, 3, 4, 5, 6, 7, 8, 9, 10, 11, 12}, in case the optimal decomposition in the step S2 is 2, the decomposed results can be {111222222111}, in the decomposed results, 1 in the bracket means that the node shall be in the first block, 2 means that the node shall fall in the second block. It can be known that, the third and the fourth nodes are in different blocks, the ninth and the tenth nodes are in different blocks, select randomly a node from the third, the fourth, the ninth and the tenth nodes (the selection criterion can be a node with a smaller serial number) to be a node of the coupling matrix, re-sequence and the new numbers after the optimal decomposition can be obtained {1, 2, 3, 11, 6, 7, 8, 9, 10, 12, 4, 5}
S5: re-sequencing the second-order finite element matrix according to the re-numbered, that is, the new numbers of the nodes and generating the new final finite element matrix as shown in FIG. 8; that is, re-ordering the original second-order finite element matrix according to the new numbers of the nodes, and generating a new blocked matrix (the final finite element matrix), subsequently, re-sequencing right-hand members of the excitation end utilizing the new nodes, and applying parallel solving for the blocked matrices and the blocked items to the right; specifically, in finite element analysis and numerical calculation, the most important is to solve the equation Ax=b. wherein A is an array of N×N, for finite element problems, A is a sparse matrix, x is an unknown column vector N×1, b is an excitation vector N×1, is also called a right-hand member vector. Where N is very big, for example, over 1 million, it will be very slow to call the commercial matrix solver to solve the unknown x, in FIGS. 4 and 5, the matrix models prior to and after blocking are given, by using the features of the blocked matrices, the solving of the matrices can be accelerated. FIG. 4 is a schematic diagram describing Ax=b, wherein A represents a large sparse matrix; x represents an unknown amount; b is a right-hand member; FIG. 5 shows a blocked matrix and the equation Ax=b, wherein A1, A2, A3, A4 show blocked sub-matrices; A5 is a coupling matrix, Eᵢ(i=1, 2, 3, 4) and Fᵢ(i=1, 2, 3, 4) are employed to describe the sub-matrices A1, A2, A3, A4 and coupling of the matrices, xᵢ(i=1, 2, 3, 4) corresponds to the unknown amounts after blocking; bᵢ(i=1, 2, 3, 4) corresponds to the right-hand members after blocking, for the blocked matrices, parallel solving of the sub-matrices A1, A2, A3 and A4 can be done to improve the computation efficiency.

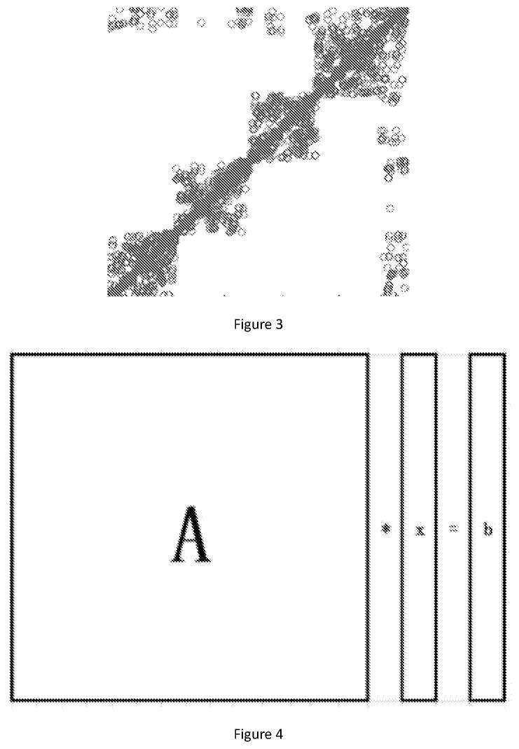

As can be seen in FIGS. 2 and 3, for the matrix before blocking, the elements in the matrix are disordered, after blocking, the elements are blocked into four blocks, the coupling in each block is arranged in the sub-matrices at the upper right corner in FIG. 3, after blocking, the element in each of the sub-matrices are less, multiplication and division operations required for solving are less, in conjunction with multi-thread parallel technology, the solving efficiency can be greatly accelerated. Further, by re-generating the matrix according to the new numbers of the nodes does not require re-filling the matrix, the re-arrangement speed is high, it is not necessary to generate the matrix with new grid data; as shown in FIG. 8, the portion a in the left portion of FIG. 8 is the second-order finite element matrix, the portion b to the right represents the new final finite element matrix, and the final finite element matrix has DBBD (double bordered block diagonal) features;
S6: solving the final finite element matrix, as the final finite element matrix has the DBBD features, which can be used for solving, for the specific solving method, please refer to the literature: [1] Stabilized bordered block diagonal forms for parallel sparse solver. Parallel computing. 31(2005)275-289; [2] Parallel direct methods for Block-Diagonal-Bordered sparse matrices. ResearchGate/2296092.

The present invention provides a method to restore the connection relationship between port nodes for the initial matrix, and provide accurate and complete supports for subsequent steps, avoid the occurrence of sub-matrices with different condition numbers and promise the solving precision of the matrix; secondly, by converting the second-order finite element matrix to un-directed graph and decomposing, the expenses and efficiency problems due to direct decomposition of the grid files in the past can be changed; further, by re-numbering the nodes of the second-order finite element matrix according to the optimal decomposition and generating the new final finite element matrix, occurrence of a very large coupling matrix in the new final finite element matrix can be avoided, the solving of the matrix can be further accelerated; finally, by solving the final finite element matrix, the solving speed is further improved; with the present method, while promising the solving precision, the solving efficiency is significantly improved, the operation is simple, easy to implement, and can be widely used in the EDA industry.

### Embodiment 2

A system employing the method for accelerated solving of large sparse matrix, comprising:
A restoration module: configured to restore connection relationships between port nodes in an initial finite element matrix, and obtaining a second-order finite element matrix;
A conversion module: configured to convert the second-order finite element matrix to an un-directed graph;
A decomposition module: configured to decompose the un-directed graph and obtain optimal decomposition;
A re-numbering module: configured to re-number nodes of the second-order finite element matrix according to the optimal decomposition of the decomposition module;
A re-sequencing module: configured to re-sequence the second-order finite element matrix according to the nodes in the re-sequence module, and generate a final finite element matrix;
A solving module: configured to solve the final finite element matrix in the re-sequence module; and
A control module: configured to control work of the other modules.

Those of ordinary skill in the art shall appreciate that, all or some of the processes in the foregoing method embodiment can be done by having a computer program to instruct corresponding hardware, and the computer program can be stored in a non-volatile computer readable storage medium, and can include the processes as set forth in the foregoing method embodiment when being executed by a computer.

In the present invention, by restoring the connection relationship of nodes in the initial finite element matrix, converting to the un-directed graph, decomposing the un-directed graph, obtaining optimal decomposition, re-numbering the nodes in the second-order finite element matrix according to the optimal decomposition, and re-sequencing the matrix according to the new numbers, finally the matrix is solved; while promising the accuracy, the efficiency can be improved in the meantime, a good balance can be achieved in between precision and efficiency, the modules are working individually and cooperatively, the structure is simple and it is easy to control.

### Embodiment 3

A computer readable storage medium, wherein a computer program is stored in the computer readable storage medium, the computer program will execute the foregoing method when being executed by a processor. The computer readable storage medium comprises for example, systems, apparatuses or appliances of electricity, magnets, optics, electromagnets, infrared rays or semi-conductors, or any combination thereof.

The foregoing is only a description of the preferred embodiments of the present invention, without limiting the idea and the scope of the present invention, without departing from the essence of the present invention, all variations and improvements to the technical solution of the present invention made by those skilled in the art shall fall into the protection scope of the present invention.

1. A method for accelerated solving of large sparse matrix, comprising:
S1: restoring connection relationships in between port nodes for an initial finite element matrix and obtaining restored second-order finite element matrix;
S2: converting the second-order finite element matrix to be an undirected graph;
S3: decomposing the undirected graph, and selecting optimal decomposition via an evaluation function;
S4: renumbering nodes of the second-order finite element matrix according to the optimal decomposition;
S5: re-sequencing the second-order finite element matrix according the renumbered nodes and generating a new final finite element matrix; and
S6: solving the final finite element matrix.

2. The method for accelerated solving of large sparse matrix according to claim 1, wherein the step S2 comprises:
S21: defining two new data structures: dots and edges, dots: a column where a non-zero element is located comprises a node corresponding to a line, and the line is the line where the non-zero element is located; edges: an edge formed by a node corresponding to the column where the non-zero element is located;
S22: mapping every non-zero element in each line of the second-order finite element matrix to be dot-dot connection relationships;
S23: every two dots correspond to an undirected edge; and
S24: repeating the steps S22 to S23 in sequence, until the connection relationships are formed in between the non-zero elements in each line of the second-order finite element matrix and generating finally the undirected graph.

3. The method for accelerated solving of large sparse matrix according to claim 1, wherein in the step S3, a definition of the evaluation function is: decomposing a matrix to be N sub-matrices, N is a multiple of 2, a coupling coefficient of the sub-matrices S is obtainable by dividing a dimension of a coupling matrix with an average dimension of the sub-matrices, and the optimal decomposition comprises a number of sub-matrices where the coupling coefficient is minimum.

4. The method for accelerated solving of large sparse matrix according to claim 1, wherein in the step S3 Metis program is used for decomposition of the undirected graph.

5. The method for accelerated solving of large sparse matrix according to claim 1, wherein in the step S1, the initial finite element matrix comes from: reading grid files, modeling finite element values via grids and creating the matrix.

6. The method for accelerated solving of large sparse matrix according to claim 5, wherein in the step S1, while generating the initial finite element matrix, copying the connection relationships of the port nodes and other grid nodes for back-up.

7. A system employing the method for accelerated solving of large sparse matrix as recited in claim 1, comprising:
a restoration module: configured to restore the connection relationships of the ports and nodes for the initial finite element matrix and obtaining the second-order finite element matrix;
a conversion module: configured to convert the second-order finite element matrix to be un-directed graphs;
a decomposition module: configured to decompose the un-directed graphs and achieving optimal decomposition;
a renumbering module: configured to renumber the nodes in the second-order finite element matrix according to the optimal decomposition of the decomposition module;
a re-sequencing module: configured to re-sequence the second-order finite element matrix according to the renumbered nodes in the renumbering module and generate the final finite element matrix;
a solving module: configured to solve the final finite element matrix in the re-sequence module; and
a control module: configured to control work of the other modules.

8. A computer readable storage medium, wherein a computer program is stored in the computer readable storage medium, wherein the computer program will execute the method as recited in claim 1 when being executed by a processor.

9. The method for accelerated solving of large sparse matrix according to claim 3, wherein in the step S3 Metis program is used for decomposition of the undirected graph.
